(19) United States
(12) Patent Application Publication
(10) Pub. No.: US 2008/0103944 A1
(43) Pub. Date: May 1, 2008

(54) Intelligent Pallet

(75) Inventors: Ronald T. Hagemann, Edgerton, WI (US); James Gerard Gaspard, Loveland, CO (US); Thomas Wittwer, Colorado Springs, CO (US)

Correspondence Address: REINHART BOERNER VAN DEUREN P.C., 2215 PERRYGREEN WAY, ROCKFORD, IL, 61107, US

(73) Assignee: Mobile Logistics Management L.L.C., Loves Park, IL (US)

(21) Appl. No.: 11/927,770

(22) Filed: Oct. 30, 2007

Related U.S. Application Data
(60) Provisional application No. 60/863,513, filed on Oct. 30, 2006.

(51) Int. Cl. G06Q 10/00; B65D 19/38; G06Q 30/00; G06Q 40/00

(52) U.S. Cl. 705/28; 108/51.11; 705/1; 705/32

(57) ABSTRACT

A intelligent pallet having and active RFID tag embedded therein is provided. The pallet is used within a leasing system and/or an inventory management system.

### CROSS-REFERENCE TO RELATED PATENT APPLICATIONS

This patent application claims the benefit of U.S. Provisional Patent Application No. 60/863,513, filed Oct. 30, 2006, the teachings and disclosure of which are hereby incorporated in their entireties by reference thereto.

### FIELD OF THE INVENTION

This invention generally relates to pallets and, in particular, to intelligent composite pallets formed from agricultural materials and employed in an inventory monitoring method.

### BACKGROUND OF THE INVENTION

Pallets are platforms used to move goods from place to place (e.g., warehouse to retail store). When a desired amount of goods has been loaded or stacked on the pallet, a fork lift, hand jack, or other device is typically slid under and/or through the pallet such that the pallet can be lifted vertically off the ground. When hoisted up, the pallet and the products stacked thereon may be transported to a storage area in a warehouse, loaded onto a truck used to distribute the goods, or taken to some other location as desired. Using pallets, numerous products may be conveniently moved and stored in groups to increase shipping and transportation efficiency.

Quite often, the pallets noted above are constructed of wood. These wooden pallets are inexpensive, flexible, replaceable, and can sometimes be recycled. However, these wooden pallets are not very durable, tend to absorb water, are flammable, subject to pest and insect infestation, splinter or break and get discarded after use, are relatively heavy when made of hardwood, difficult to clean, and have other disadvantages.

Instead of wood pallets, some in the shipping and freight industry have adopted and use metal or plastic pallets. While these non-wood pallets are more durable, less subject to infestation, and are not improvidently thrown away, they are much more expensive than their wooden counterparts. Therefore, the loss or theft of these metal or plastic pallets is costly to those businesses who have to replace them.

There exists, therefore, a need in the art for a non-wooden pallet that can be monitored and/or tracked along with the goods carried by the pallet. The invention provides such a pallet and inventory control system and method. These and other advantages of the invention, as well as additional inventive features, will be apparent from the description of the invention provided herein.

### BRIEF SUMMARY OF THE INVENTION

One aspect of the present invention is directed toward a composite material pallet incorporating an active radio frequency identification (RFID) tag. While it would not seem intuitive to provide the industry with a pallet that is made with more expensive material and a more expensive type of RFID technology, several advantages over the prior art are provided through this unique combination. First, the more expensive active RFID technology (compared to passive RFID technology) has a longer life span due to the fact that non-wood pallets (which dominate the industry) are being used. In particular, non-wood pallets such as composite material pallets (or plastic pallets) have a much longer life span as opposed to simple wood pallets. On the other hand, the active RFID technology utilized on these more expensive composite pallets can be employed as a means to track the pallets and prevent theft, loss or otherwise provide for inventory statistics as a means to increase the overall life span and longevity of the pallet. As a result, an active RFID non-wood pallet can be subject to an increased life span and facilitate more turns between warehouses and destinations. This is due to in part the fact that the active RFID technology can by itself generate a signal and does not have to rely on simple passive technology.

Another inventive aspect is directed toward the incorporation of an active RFID tag into a pallet in a pallet lease system. The system includes a plurality of pallets made from non-wood material such as composite material and an active RFID tag that is embedded in, or mounted to, the pallets. The system further includes at least one distribution location such as a warehouse and at least one destination location such as a retail center. At least one of these locations can preferably both include RFID readers as part of data loggers as a means to track and monitor the turns of the pallet between locations within the system.

Yet a further aspect of the invention is an inventory control system incorporating active RFID tags mounted to a plurality of pallets. The active RFID tags carry information relative to the inventory or contents contained on the pallets which is periodically updated and modified and read by a reader of a data logger that coordinates with inventory control management software.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an exemplary embodiment of a composite pallet, which has product stacked thereon, in accordance with the teachings of the present invention;

FIG. 2 is a cross section of the pallet of FIG. 1 taken generally along line 2-2 to highlight the active radio frequency identification (RFID) tag embedded therein;

FIG. 3 is a simplified schematic of the active RFID tag of FIG. 2;

FIG. 4 is a table illustrating weight savings for composite material such as that used in the pallet of FIG. 1;

FIG. 5 is a simplified schematic of the pallet of FIG. 1 within a leasing system;

FIG. 6 is a table illustrating examples of the monitoring capabilities of the leasing system of FIG. 5;

FIG. 7 is a table illustrating examples of action capabilities of the leasing system of FIG. 5; and

FIG. 8 is a simplified schematic illustrating one example of an overall smart pallet system using the pallet of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

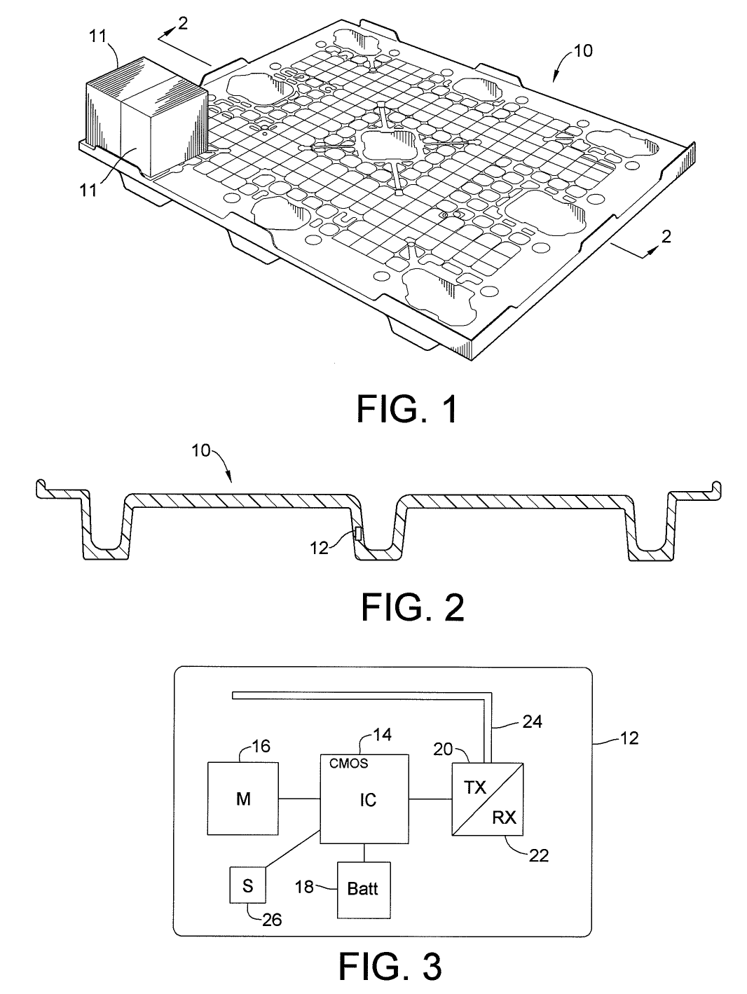

Referring to FIG. 1, a “smart” composite pallet 10 is illustrated. The pallet 10 may be constructed from, at least in part, composite materials including agricultural materials. Because the pallet 10 also includes or is formed from synthetic materials such as, for example, plastics, resins, polymers, and the like, the pallet has numerous advantages over wood pallets. For example, the pallet 10 is durable, waterproof or water resistant, inflammable, resistant to infestation, treated as an asset, lightweight compared to hardwood, relatively inexpensive, and may contain recycled material. The biomaterial product described in this application reduces profile density by 20-25% therefore reducing weight substantially per type of plastic used in the manufacturing of the pallet.

The bio-composite pallet has been tested according to ASTM DI 185 “Standard Test Methods for Pallets and Related Structures Employed in Materials Handling & Shipping” and ASTM D642 “Standard Test Method for Determining Compressive Resistance of Shipping Containers, Components, and Unit Loads.” The pallet 10 is designed to hold and/or secure, for storage and transportation purposes, products 11 having a variety of shapes and sizes. In addition, the pallet 10 may include permanent or collapsible side walls such that the pallet forms or resembles a bin or container. In some cases, RFID tags are secured to the products 11 such that the products themselves can be readily identified, tracked, and/or provide information and data.

The bio-composite pallet 10 is also manufactured utilizing Polyethylene vinyl acetate (CAS# 24937-78-8, also known as EVA or sometimes simply as “acetate”) pellets. The EVA pellets described in this application are designed to minimize or eliminate burn off odor and as well minimizing burn coloring which occurs during the manufacturing process. The beads are filled with up to 65% odor neutralizer and 35% with a fragrance. Samples of these fragrances are “cedar” and “oak,” to name a few. In essence, a person can produce a reground plastic/bio-based pallet that smells like a wood pallet. This is beneficial if a pallet is to be brought indoors, for example, as a floor pallet in a retail store.

As shown in FIG. 2, the pallet 10 features an embedded active radio frequency identification (RFID) tag 12 within the composite material of the pallet. The active RFID tag 12 includes interactive features and operates in cooperation with an interactive communications software system as explained more fully below. Because the RFID tag 12 is embedded within the composite material of the pallet 10, the circuitry and components of the RFID tag are generally protected from external hazards that the pallet 10 likely encounters. For example, the embedded active RFID tag 12 is sheltered from the elements (e.g., rain, snow, etc.) and contaminants from the outside environment (e.g., dust, dirt, soot, water, etc.). In addition, the enclosed RFID tag 12 is safeguarded from those objects striking or impacting the outer surfaces of the pallet during everyday and/or normal use of the pallet.

Referring to FIG. 3, the RFID tag 12 includes an integrated circuit 14 (IC), a memory 16, a battery 18, a transmitter 20, a receiver 22, and an antennae 24 in electrical communication and otherwise operably coupled together. In one embodiment, the IC 14 is a complementary metal-oxide-semiconductor. The RFID tag 12 is preferably embedded in the central leg of the pallet 10 in FIG. 2. However, the RFID tag 12 may be suitably embedded in a variety of other locations as well.

The memory 16 is preferably non-volatile so that any data stored therein is not lost upon power down of the IC 14. Examples of such non-volatile memory include, but are not limited to, erasable programmable read only memory (EEPROM) and flash memory. Preferably, the memory 16 stores some type of identification number that corresponds to the particular one of the pallets 10 where the RFID tag 12 is embedded. Therefore, the RFID tag 12 is able to identify the pallet 10 associated therewith.

Data is input into the memory 16 at any location using a portable programmer technology. As such, it is possible to change the items being monitored by the tag 12 at any stage of the life of the pallet 10 or at any stage of the transportation cycle of a turn. In a normal model, the tags 12 will only be changed at the collection center once a pallet comes off lease with one customer and then rerouted to a different end user that requires differing data to be collected.

The battery 18 generally powers the IC 14 such that the IC can send and receive signals using the transmitter 20, receiver 22, and the antennae 24. Because of the inclusion of the battery 12 (or another internal power source) and the ability of the RFID tag 12 to use this battery to communicate with the reader (discussed more fully below) and to actively rather than passively function, the RFID tag 12 is known as an active RFID tag. The active RFID tag 12 has a greater range than, for instance, a passive tag and can enter into a communication session with a reader.

The RFID tag 12 further may include a sensor 26 for sensing one or more characteristics or qualities of the pallet 10 and/or the environment surrounding the pallet. The sensor 26 is able to sense any number of qualities such as, for example, temperature, humidity, pressure, load on the pallet 10, and the like.

The pallet 10 preferably includes bio-based elements in the manufacturing process along with the embedded RFID capabilities. This provides an opportunity to use agricultural inputs in the pallet 10 and to allow corn production to expand into the area of composite manufacturing. Standard input materials currently used in the composite industry have been almost completely petrochemical based. In regard to the pallet 10, composite manufacturing utilizing agricultural input materials such as corn reduces the relative content of petrochemicals and reduces the cost of the base material in composite manufacturing while promoting renewable sources.

The use of RFID allows for highly efficient operations. An active RFID tagging system utilizing the RFID tags 12 allows for dataset identification and live updates of information for individual, partial, or whole activities of goods interacting with a central database location. The pallet 10, which includes the RFID device 12, uses interactive software and allows for leasing as will be more fully explained below. The pallet 10 includes integral tracing capabilities which offer identity-preserved system efficiencies and safety capabilities in the process.

Proprietary Biocomposite Manufactured Pallet

When forming the pallet 10, composite materials are used. Composite materials are created by combining two or more materials to produce a new material that retains important properties from the original components. These unique combinations deliver significant advantages over traditional materials in a wide variety of structural applications. Composites comprise a matrix material that is then reinforced with fibers that can be taken from ceramics, metals, or polymers. The reinforcing fibers are the primary load carriers of the material, with the matrix component transferring the load from fiber to fiber. Reinforcement of the matrix material can be achieved in a variety of ways including particles. Fibers may be continuous or discontinuous with the matrix material usually sourced from one of the many available engineering polymers.

For manufacturers of the pallet 10, composites offer a flexible solution with the advantage of being able to select just the right combination of fiber reinforcement and resin material to meet both the application and property requirements of a finished part.

In the illustrated embodiment, for example, the biocomposite products used in the pallet 10 are created using agricultural-based materials and innovative production processes described in pending U.S. patent application Ser. No. 11/492,470 entitled “Composite Material With Grain Filler And Method Of Making The Same” and in pending U.S. Pat. Appln. No. 60/983,387 entitled “Bio-Plastic Composite Material, Method Of Making Same, And Method Of Using Same,” which are incorporated herein in its entirety. Indeed, the bio-composite pallet is manufactured by injection molding, thermoforming, and compression molding manufacturing processes utilizing raw material described in the above-noted pending U.S. Pat. Appln. The applications of materials science create strength properties of steel with various thermal coefficients of expansion to mimic thermal properties of wood, concrete or steel. The recipe for the composite products includes resins utilizing bio-based raw materials made with soybean or corn oil. Their properties are optimized by using foam filler manufactured from dried distillers grain (DDG), which is an ethanol by-product.

The current structural composite resin can use up to twenty percent (20%) agricultural based inputs. Bio-based resins have a renewable source that can be lower cost because the input materials are less expensive than petrochemicals. General purpose polyesters made from ethanol/soy-based polyesters will perform similar to any general purpose resins and can be used in standard composite manufacturing methods.

Composite materials being petrochemical based has two large disadvantages. First, this is a limited resource whose growing consumption negatively affects almost all aspects of our lives. Second, the increasing cost of petro-based composite materials is a drag on the commercialization of composites into new products and prevents customers from realizing the benefits of composite materials. Composite manufacturing utilizing agricultural input materials such as corn reduce the relative content of petrochemicals and reduce the cost of the base material while promoting renewable sources.

The current proprietary biocomposite compression molding manufacturing method utilized in forming the pallet 10 is a process of applying heat and pressure to a plastic resin in matched dies. The resin melts due to the heat, and then the pressure causes it to form into a desired shape. This is done in a compression molding press. Plastic parts made from polymeric resins are capable of forming chemical crosslinks. This formation of chemical crosslinks is often referred to as curing. During this process, polymer molecules bind together through crosslinking creating a complex network that will not melt. Thermoplastic materials can also be used in the compression molding process.

In illustrated embodiment, for example, compression molding is employed to form the pallet 10. Compression molding is a term that encompasses several different technologies. Sheet molding compounds (SMC), structural molding compounds, and thermoplastic can all be compression molded on various specialized equipment. One attribute compression processes have in common is the use of pre-manufactured material or “charge.” The pre-manufactured material is pressed into shape and cured during the molding operation. The compression molding process is presently the most technologically developed and incorporates either continuous or random chopped fibers into a structural composite.

The compression molding process is more rapid and complex than the labor intensive hand lay up or liquid matched die molding methods that it often replaces, but it has a trade off with respect to fiber alignment. Depending on the component shape and charge pattern, compression molding may involve regions of high resin flow that tend to orient fibers in the flow direction. Random orientation is desirable for chopped fiber sheet molding compound and long fiber thermoplastic materials. If directional fibers are desired, flow patterns can be developed. Fiber utilization in compression molding materials is very versatile. Continuous, cut length, or chopped glass fibers may be used, as well as random continuous glass mats. Carbon or aramid fibers may also be used. Sheet molding compounds can be made in various compositions and by various processes. Continuous, unidirectional molding compounds for structural components generally have about forty (40) to about sixty (60) wt % glass fiber reinforcement.

Material cost for compression molded SMC are estimated to be approximately three and a half times the cost of steel by weight and several times that of wood. To compete, polyester composites must integrate several parts into one, to save assembly, floor space and storage costs. One opportunity to reduce cost is the use of fillers in the pallet 10 to minimize resin cost and lower thermal expansion of the product. Resin chemistry has a major influence on the strength and reliability of the final composite component. Although the resin constitutes only sixteen (16) to twenty-five (25) wt % of a typical SMC composite, it controls flow and moldability.

In the illustrated embodiment, for example, the bio-based SMC product for the pallet 10 uses the same base resin used in low temperature cured laminates. Therefore, it is possible to maintain a Class A surface and build barcol hardness at temperatures utilizing the bio-based resin below the three hundred degrees Fahrenheit (300° F.) used in SMC. The target temperature to mold at will be set from about seventy-seven degrees Fahrenheit (77° F.) to about one hundred forty degrees Fahrenheit (140° F.).

Because composites offer unique combinations, the pallet 10 delivers significant advantages over pallets formed from traditional materials and does so in a wide variety of structural applications. There are several advantages that the composite of pallet 10 offers over pallets from traditional materials.

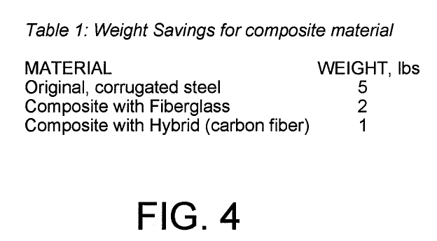

One of the above-noted advantages is that the pallet 10 is lightweight. The optimization of weight in the use of composite product versus steel and aluminum (of comparable strength) allows for energy savings, as less fuel is required for hauling the composite product than the steel version. For example, an eighty square foot product weighs in at about five hundred and forty-five pounds when made of 11-gauge steel. One of the pallets 10 having the same dimensions, and formed from the composite material, weighs in at about two hundred and five pounds while maintaining the same tensile strength. This optimized design produces the results listed in Table 1 of FIG. 4.

Other advantages of the pallet are that they have high strength and stiffness tailored to meet the requirements, are corrosion resistance, are large unitized parts, have design flexibility, are durable, are fatigue resistant, have excellent insulation capabilities, reduce system and maintenance costs, are ballistic grade, rodent resistance, and the like.

Proprietary Active Radio Frequency Tag

The active RFID system in the pallet 10 uses radio frequency energy to communicate between a tag and a reader. As noted above, active RFID uses an internal power source (e.g., a battery 18) within the tag 12 to continuously power the tag and its RF communication circuitry. The battery 18 is preferably sized to provide a lifespan of between about one to about five years, perhaps longer.

Active RFID allows very low-level signals to be received by the tag 12 (because the reader does not need to power the tag), and the tag can generate high-level signals back to the reader, driven from its internal power source. Additionally, the active RFID tag 12 is continuously powered, whether in the reader field or not. As discussed in the next section, these differences impact communication range, multi-tag collection capability, ability to add sensors and data logging, and many other functional parameters.

Active RFID tag 12 has no constraint on power and can provide communication ranges of a quarter mile. Active RFID is able to collect thousands of tags 12 from a single reader. Additionally, tags 12 can be in motion at more than one hundred miles per hour (100 mph) and still be accurately and reliably collected. One functional area of great relevance of the active RFID system in the pallet 10 to many supply chain applications is the ability to monitor environmental or status parameters using an RFID tag 12 with built-in sensor capabilities (e.g., the sensor 26). Parameters of interest may include temperature, humidity, and shock, as well as security and tamper detection.

Active RFID tags 12 are constantly powered, whether in range of a reader or not, and are therefore able to continuously monitor and record sensor 26 status, and can power an internal real-time clock and apply an accurate time/date stamp to each recorded sensor value or event. Active RFID tags 12 have the flexibility to remain powered for access and search larger data spaces, as well as the ability to transmit longer data packets for simplified data retrieval. Active RFID tags 12 are in common use with 128 K bytes (1 million bits) of dynamically searchable read/write data storage.

Because of the above capabilities, active RFID tags 12 are best suited where business processes are dynamic or unconstrained, movement of tagged assets is variable, and more sophisticated security, sensing, and/or data storage capabilities are required.

One key technical performance parameters of an active RFID system using the tags 12, which is directly related to the frequency of operation, is the maximum communication range and propagation within crowded environments. As a general rule, radio signals at lower frequencies will propagate farther than signals at higher frequencies, assuming similar transmitter power levels. The attenuation (or decrease) of a radio signal as it travels through a medium such as air is directly related to its wavelength. All signals experience the same decrease in signal strength per wavelength when traveling through the same medium.

Because signals at lower frequencies have longer wavelengths, signal attenuation occurs at a slower rate. For example, if Signal A decreases by ten percent (10%) over a distance of ten (10) feet, then a signal at half of the frequency of Signal A will decrease by ten percent (10%) over a distance of twenty (20) feet, thereby allowing the lower frequency signal to propagate farther. At frequencies less than one hundred megahertz (100 MHz), other factors have a greater impact on practical communication range. Systems at lower frequencies, such as thirteen and fifty-six hundredths megahertz (13.56 MHz), depend on inductive coupling as the primary mode of interaction. The range of an inductively coupled system drops sharply with distance, making communication beyond about ten to twenty feet impractical. Using longer-range electrical coupling at these frequencies is not recommended due to their high susceptibility to noise and interference from other devices.

The ability for signals to propagate within crowded environments is also dependent on the signal wavelength, and hence frequency. The ability for an RFID system using active RFID tags 12 to operate in and around obstructions is helpful. These obstructions are often metal requiring signals to propagate “around” rather than “through” the obstructions. Active RFID signals propagate “around” obstructions by means of diffraction, and the level of diffraction is dependent on the size of the object versus the signal wavelength. Diffraction occurs when the wavelength approaches the size of the object. For example, at four hundred thirty-three megahertz (433 MHz), the wavelength is approximately a meter, enabling signals to diffract around vehicles, inter-modal containers, and other large obstructions. At two and four tenths gigahertz (2.4 GHz), the wavelength is approximately a tenth of a meter and diffraction is very limited with these obstructions, thereby creating blind spots and areas of limited coverage. Frequencies above two gigahertz (2 GHz) present significant challenges for operation in crowded environments and are therefore not recommended for most RFID applications.

Proprietary Interactive Software and System

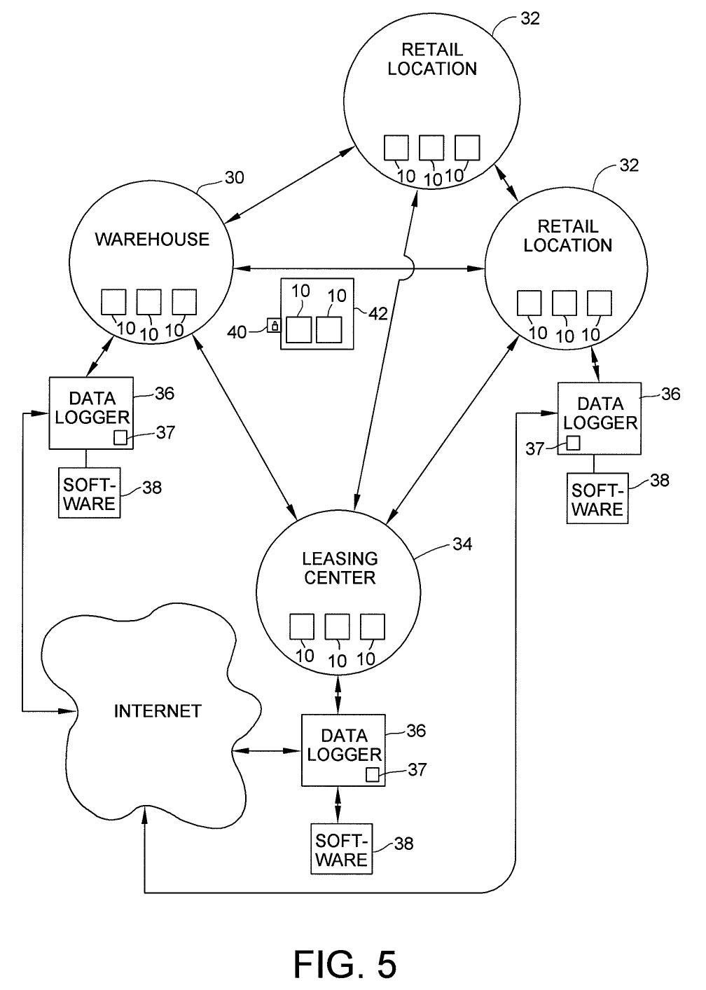

In one embodiment illustrated in FIG. 5, the invention also utilizes a data logging communication and software system 28. The system 28 either includes, or operates along with, a warehouse 30, a retail location 32, and a leasing center 34, which each have data loggers 36 (e.g., computers). The data loggers 36 preferably include or operate using specialized software 38, which will be explained more fully below. The data loggers 36 also preferably include radio frequency communication equipment 37 (e.g., transmitter, receiver, antennae, etc.) such that the data loggers are able to communicate wirelessly. In addition, the data loggers 36 are connected through and/or communicate with each other through a network such as, for example, the Internet, a local area network, a wide area network, and the like. If desired, the data loggers 36 can be equipped with wireless communication equipment (e.g., transmitters, receivers, antennae, etc.) to communicate with each other as well as other components having wireless communication abilities. Using the system 28, the pallets 10 are efficiency leased, supplied, swapped, and otherwise moved between the leasing center 34, warehouse 30, and retail locations 32.

The system 28 has the advantage of being transmitted and received through a large number of mediums. The system 28 uses a global application to replace several specialized applications. This makes the system 12 very cost effective option and versatile. The software allows access to needed data all the time. The system 28 collects information and enables action. The software 38 allows monitoring and control of assets from nearly anywhere in the world from any internet ready device. Using state of the art mapping, assets can be monitored down to street number level world wide where available and geo fenced giving a complete visual picture. Assets can be measured in a multitude of ways, optimized and controlled.

The system 28 also gives the user complete freedom to use the type of reporting deemed most suitable under the particular circumstances. For example, reports are fully customizable to include only desired content. In addition, the content is displayed in a desired or user defined format. Reports are scheduled and customized for different groups of users. The software 38 gives a user of the system 28 a choice so that the user has complete and relevant information.

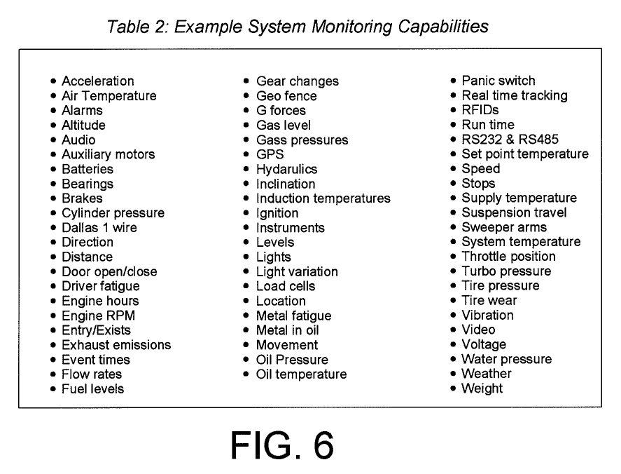

Within the system 28, the items listed in Table 2 of FIG. 6 are monitored by the software 38 and/or the sensor 26. The software 38 securely and quickly pulls and/or stores the data from the data logger 36. In one example, the data loggers 36 are placed proximate a large distribution center with many loading doors, thousand of pallets 10 going through on a daily basis, and a fleet of forklifts to service the facility. The receivers in the data loggers 36 are placed in areas that allow full coverage of the facility. The receivers can then all feed back their data into one central data logger within the distribution center via hard wire or wireless capabilities.

Each different location (e.g., warehouse, destination/retail store, leasing center, etc.) will have an individually structured strategy for coverage. The RFID cannot broadcast through steel or water. So if the facility has a large number of steel walls or a standing water problem where the pallets 10 will be underwater at times, it will take a different strategy than a free standing area with wooden or sheetrock walls that the RFID can transmit through.

Possible coverage strategies may be as simple as mounting receivers throughout the building where there is no uncovered areas. Or receivers can be mounted on individual forklifts to monitor data as the forklift moves around the facility. Alternatively or in addition, only areas proximate the doors are monitored to track the items entering and leaving and not while within the facility. For example, many facilities have a single or multiple security gates and data loggers 36 may be located only at these gates if desired.

The software 38 submits user instructions to the data logger 36 for management of the pallet 10 or other asset (e.g., the goods on the pallet). If the software 38 is not directly installed on the data logger 36, the software is able to connect to and operate on the data logger thru cellular modems, satellite modems, point to point radios, the Internet (3G, GPRS & CDMA), and the like.

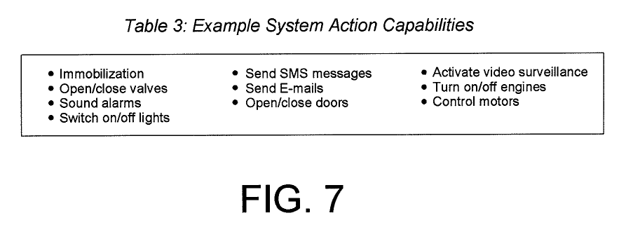

Within the system 28, the actions listed in Table 3 of FIG. 7 can be performed. As a result, functions other than simply tracking “turns” are available. As referenced above, the system 28 has many abilities. In many applications, there is a need to continuously or periodically monitor the presence and status of tagged pallets 10, assets, or other items over a large area. The system 28 collects real-time inventory information within the warehouse 30. Examples of this are monitoring the location of empty and loaded air cargo containers including the pallets 10 across an air terminal or tarmac or the security of ocean containers or trailers including the pallets stored in a yard or terminal. The system 28 addresses the need for long-range communication. The system 28 allows for high-speed, multi-tag 12 portal capability. Portals, through which the pallets 10 eventually pass, of various sizes, shapes, and uses are common throughout supply chains. That means any sort of gate, doorway, or other opening through which items move fits this category. This includes, but is not limited to, dock doors at a distribution centers, entry/exit gates at an inter-modal terminals, and conveyor checkpoints within a parcel sorting operation. The system 28 allows for large portal applications, such as roadside monitoring of an eight-lane highway.

In the embodiment shown in FIG. 5, the system 28 employs RFID-based electronic seals 40 on containers 42 holding the pallets 10. These seals 40 are an effective means of securing all forms of cargo carried over the ocean, in the air, over land, and by rail. The system 28 offers security solutions for applications where tamper detection is important.

The smart pallet 10 also utilizes an active RFID system of tags 12 that allows remote tracking from a distance by identifying the pallet and the goods 11 or other items on the pallet utilizing the logistics and inventory tracking system of the user. The pallet tracking system 28 or system of the user may consist of several components such as, for example, a radio, power source, tags, tag readers, tag-programming stations, circulation readers, sorting, and data logging equipment. The purpose of these systems is to enable data to be transmitted by a portable device, which is the tag 12, embedded in a biocomposite pallet 10 read by the RFID reader 46 and processed according to the needs of the particular application. The data transmitted by the tag 12 provides identification or location information, or specifics about the products 11 on the pallet 10, such as point of origin, price, color, date of purchase, and the like. The uniqueness of the system 28 is the ability to link an active RFID logging informational system as well as the ability to utilize passive tracking systems currently used in the marketplace for products shipped on pallets 10. Also, if desired, the RFID tags on the products can communicate or exchange information with the RFID tags 12 on the pallet 10.

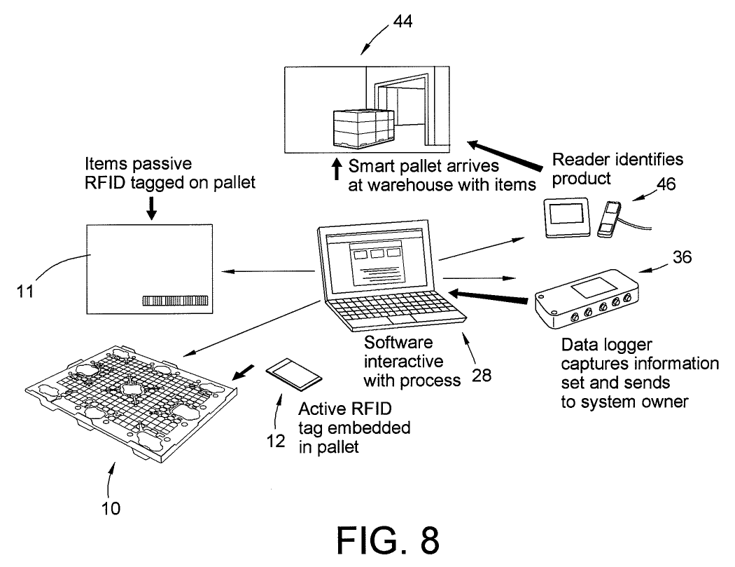

As shown in FIG. 8, the working system 44 includes an active RFID tag 12 which is embedded into a biocomposite manufactured pallet 10. The pallet 10 is loaded with goods 11, perhaps including passive tags from the supplier, and transported to a warehouse 30. On the truck, the logging system 44 is installed to track the pallet 10 and its goods 11 or other contents in transit as well as provide real time information from the list of monitoring capabilities listed in Table 2, as well as perform any action capabilities listed in Table 3. This occurs anywhere because the logging system 44 has communication capabilities through cellular modems, satellite modems, and point to point radios.

When the pallet 10 arrives at the warehouse 30, the same logging capabilities are available as described with the truck. The data is then be stored, in the memory 16 and/or the data logger 36, and sorted within the software system 44, which can be Internet interfaced to facilitate informational queries.

In one embodiment, the system 44 uses a lease (from system 28) whereby the owner of the pallets 10 rents and/or grants to a renter the right to use, and the renter rents from and/or agrees to accept the right to use, subject to the terms and conditions herein set forth, a fixed number of the pallets 10 which will be delivered to the renter at a specified location. The rental shall be for a fixed period of months with monthly payments at a fixed price of a certain amount per pallet 10 per month for an initial turn, and for another fixed price of a certain amount per pallet per month for additional turns or usage. One turn per pallet per month minimum usage, commencing upon acceptance of the lease, is guaranteed. The lease shall continue monthly for a total period as decided between the parties. A “turn” is usually defined as a pallet leaving a location where it is loaded, traveling to a location where it is unloaded, and then returning to a location where it is loaded once again. According to the system 44, turns are automatically determined and monitored utilizing the active RFID tags 12 and the data loggers 36. As a result, the lease/usage fee can be readily calculated.

In another embodiment, the system 44 uses a lease whereby the owner of the pallets 10 rents and/or grants to a renter the right to use, and the renter rents from and/or agrees to accept the right to use, subject to the terms and conditions herein set forth, a fixed number of the pallets 10 for a fixed period of months. During the term of the lease and after acceptance by the renter, the Pallets will be delivered by a third party to one or more locations specified by the renter. Upon delivery, an issuance fee of a certain amount per pallet 10, a return fee of a certain amount per pallet, and an initial usage fee of per pallet will be payable by the renter to owner (collectively, the “Rent”). In addition, for each pallet not returned within a certain number of days to a designated sorting location of the third party who delivered the pallets 10, the renter will pay additional rent (“Additional Rent”) for all or any portion of each subsequent fixed periods, on a cumulative basis, until it the pallet is returned. Finally, for any pallets 10 not returned by the expiration of six fixed periods, the renter will pay Additional Rent on a daily basis until the pallet is returned to the third party.

Each pallet 10 returned by the renter to the third party will be treated as the return of the earliest pallet issued and not yet returned. After the initial delivery and issuance, for which the renter will be billed upon delivery, at the end of each month the owner will submit one bill to the renter for all Rent and Additional Rent earned during the month.

The above paragraphs only deal with the cost of the pallet 10. However, the system 44 includes tracking the pallets 10 by and through the active RFID tags 12. The customer will not normally have access to any of the data in the above illustration. There will need to be a separate agreement in place to outline what level of access the customer will have to the RFID data, along with the sales price of the data negotiated. As desired, access to the gathered RFID data may be granted for a fee or at no additional cost. If need be, the owner of the pallets 10 and the renter can negotiate a separate billing regime to break out the data requirements and format for reports to be used by management.

The above model allows the active RFID tags 12 to be embedded in the pallets 10 and in effect placed into the pallet users' facilities as a “Trojan horse” infrastructure. Once the infrastructure is in place, at no perceived cost to the customer (included in the per turn price, which is the same or lower than currently expended on wood pallets per turn) portable readers and data loggers can be used to gather appropriate information and give sample reports to the management team of the renter.

One aspect of the system 44 involves using “reprogrammable” active tags 12 embedded within the pallets. This allows each pallet 10 to be customized for a selected job after the pallet has been manufactured. Also, the pallet 10 can be assigned to a different customer who can then reprogram the pallet as needed for tracking or data requirements.

In one embodiment, the readers, data loggers and initial report writing software employed are supplied by Data Acquisitions, Ltd., of New Zealand. The data logger equipment is illustrated at www.datalogga.com and the initial software is discussed at www.liveiris.com.

In the above system 44, the owner of the pallets 10 will preferably have an exclusive arrangement with manufacturer of the data logger for the use of their data logging equipment in selected markets. The third party, who delivers the pallets 10, are a pallet management company that has the pallet management contract for other well known merchants. Even though the pallet 10 owner provides the system 44, the third party manages the day to day movement, restaging, and the like, of the pallets.

The owner of the pallets 10 works with the pallet management company to customize the software 28, or their software, for the specific applications of each customer. The software 28 (or their software) is customized to track and monitor scores of goods 11 or items as well as pallet movement (good for any distribution application), the ambient temperature of the environment the pallet is located in (good for shipments that require frozen or refrigerated environments), shock movements to the pallet (good for damage reports to electronic shipments), and the like.

The Marketplace and Proprietary Business Model Lease

In the embodiment shown in FIG. 5, the invention further includes a lease program or element operating through the leasing center 34. The system 44, without such a lease program, might not be cost effective for most business entities as the pallet industry is geared towards the use of wooden pallets. Today, there are about four hundred and fifty (450) million new pallets produced in North America each year. About one and nine tenths (1.9) billion pallets are in use at any given time.

Historically, pallets were made of solid wood. Most products experience material conversions. Over time as innovations or market changes occur, however, the pallet material of choice for the last seventy (70) years remains solid wood. This is unusual for a commodity product. While pallet users today face a wide variety of material and design choices, wood pallets are still used to manufacture about ninety to ninety-five percent (90-95%) of the US market. However, since the wood market share is so large, it will likely not increase in the future. While wood should retain the majority of the volume for many years, some global trends could increase the use of other materials. These are trends such as standardization, improved retrieval operations, more reusable pallets, and pest regulations. Disadvantages of the wood pallets however are that they have fasteners that can damage products, they have splinters, they give off moisture, can harbor bugs, and there is a lot of variation in size between different pallets.

It is estimated that plastic or composite pallets make up two percent (2%) of new pallet production in the United States, or about eight million new pallets per year. The most common materials for these composite pallets, and the pallets 10, are high density polyethylene (HDPE), polypropylene (PP), and polyvinyl chloride (PVC). Each of these is about three to six times the price of wood per pound, so a fifty pound (50 lb) plastic pallet is much more expensive than a fifty pound (50 lb) wood pallet. The most common manufacturing process is structural foam molding, but other processes include injection molding, profile extrusion, rotational molding, and thermoforming. Preferably, compression molding is used in forming the pallets 10.

General advantages of forming pallets 10 from composites are that the pallets are more durable, are cleaner, have no fasteners, are bug free, are weather resistance, and have more design potential. The composite pallets 10 are most common in captive or closed loop warehouse environments.

There are five basic interactive parameters that determine pallet 10 suitability for a given application. These parameters are strength, stiffness, durability, functionality, and purchase price. These parameters are interactive, and optimizing just one (for example, minimizing price) will impact the others. The proper balance of these five parameters will vary, depending on the specific product and distribution environments. The parameters hold true regardless of the pallet material used. Strength is the load carrying capacity throughout the shipping and storage environments. Pallets must be designed that are strong enough to support the required load. Stiffness is the resistance of the pallet to deformation under load. Sometimes a pallet won't break under load, but is not stiff enough to protect the product or prevents proper handling.

Many known pallets in the marketplace are strong enough to support the load weight, yet they create pressure points that cause the goods 11, or their packaging, to fail. For example, saving one dollar ($1.00) on a pallet with thinner decks often requires every corrugated box stacked on that pallet to be stronger to resist damage. Durability is the ability to withstand the rigors of the shipping and handling environments.

Price is an important design criterion, and often given more consideration than the other factors. If the owner does not intend to recover the pallet, then the pallet just needs the integrity to withstand one trip or turn. For returnable pallets, such as the pallets 10, the pallets are designed for a number of trips or turns to make their cost economically justified. The lease program within the system 44 further makes the pallets 10 financially feasible.

The life of reusable items, such as the pallet 10, is a function of cycle times, recovery rates, distribution channels, expected rates of return (ROI), and future expected changes to warehouses 30. This leads to pallet designs that look economical up front, but end up “costing” much more as they are used. Balance the price of the pallet versus the value of the product delivered without damage to the customer. Balance the price versus potential savings in packaging and material handling savings.

The system 44 takes into account the five parameters discussed earlier and the fact that optimizing just one will significantly impact the others. The better a potential customer of the pallets 10 and user or renter within the system 44 understandings the interactive balance of the five parameters, the more likely they are to select the ideal lease design for their product and material handling environment.

The leasing program within the system 44 utilizes the current price per pallet 10 used in the system as it costs the company. An example would be if a company uses a pallet that has a cost of twelve dollars ($12.00) new and uses the pallet to and from (which is termed a “turn”) a warehouse 30 three times before the pallet is broken and has to be replaced. That figure would suggest that the company has a pallet that is costing them $4.00 per “turn.”

Using the advantages of the durability of the composite pallet 10, we utilize the leasing program to compete with the overwhelming cost difference from wood to composite with the consumer. From studies, the composite pallet 10 averages about 100 “turns” per life of composite pallet before it is in need of repair. Therefore, the cost of the pallet 10 on a per turn basis is equal to or less than that of conventional pallets. The option of “repair” is of great benefit as well since it is possible to repair composite pallets that have become broken in use.

In offering a lease program, price objections are alleviated because the same or lesser price per “turn” with the composite pallet 10 as a consumer would pay using a wood pallet and allowing the durability of the pallet to make up for the initial monetary loss for the leasing agency.

In order to monitor turns, the active RFID tags 12 are used instead of “passive” RFID tags and bar coding. Numerous reasons led to this decision. To understand RFID's benefits, the capabilities are compared to an existing industry standard, namely the bar code. By understanding how RFID compares to bar codes, an appreciation for its potential is gained while the details of how it works are learned.

RFID tags range in size from a postage stamp to a book. The aspect ratio of a tag's 12 length versus width is very flexible and not a significant factor for the RFID reader. Bar codes are larger than the smallest tag and very sensitive to the aspect ratio for presentation to a scanner. The ratio of a bar code's length versus width is needed for its operation.

RFID tags have no moving parts and are embedded in protective material for an indestructible case and multi-year lifespan. Bar codes have unlimited shelf life but are subject to degradation with handling. RFID tags may be placed in extreme environments and perform to specification. They are very robust to handling, sensitive to environment, and generally degrade once used, stored or handled in a non-office environment.

Digital data is stored on the tag 12 and provides for a significant capability to encode the tag originator, user data as needed by the segment or application, and serial number as needed by the segment/application. Major vertical markets like retail have standards which are excellent at coding product type and manufacturer. Additional information beyond these basic parameters is not feasible because the size of the bar code becomes too large.

RFID tags are produced with a unique identity code (UIC) or serial number from the manufacturer. This is embedded digitally on the microchip and may not be changed, therefore, making them extremely resistant to counterfeiting. Bar codes may easily be duplicated and attached to products and are, therefore, easily counterfeited.

RFID tags 12 may be written to and offer on board memory 16 to retain information. This feature may be used to store a product calibration history, preventive maintenance, and the like. Updates may be made within the blink of an eye and automatically without human intervention. Once a bar code is printed it remains frozen. The code and the process of attaching the bar code are not supportive of real time updates. It is a labor-intensive process to update any information on a bar code once printed.

The combination of UIC (unique identification code), user data, serial number and on-board memory 16 makes it possible to track, recall, or document the life span of a single item such as a pallet 10 or a good 11 thereon. For example, with livestock this means that the birthplace of the animal, its vaccine history, feed lots, slaughterhouse, processor, and the like, may all be tracked. This kind of information supports a complete pedigree for an item attached to the tag. Bar code is limited to an entire class of products and unable to drill down to a unique item. It is not feasible to recall, track or document a single item.

RFID tags 12 offer a range from inches to hundreds of feet and do not require line of sight. This means that individual tags 12 placed within a carton, packed in a box and stored in the pallet 10 may be read. Each box does not have to be opened and presented for reading of the individual item. Bar code offers a range over inches and requires line of sight to read the code. The bar code must be presented to the scanner in an orientation and distance that is very limited. Individual reading requires that each box on a pallet be opened and the item pulled for presentation to the scanner.

RFID standards have algorithms to support simultaneous reading of tags 12 at one time whereas bar codes are limited to one read at a time and unable to support simultaneous reads. RFID tags 12 are reusable where bar codes are not. What jumps out from this comparison is RFID's capability to greatly amplify the benefits received from traditional bar coding. By eliminating the manual task of reading a bar code, RFID automates data entry. This permits new ways of processing items, events or transactions.

A comparison between the active RFID system in the pallet 12 and “passive” technology and “active” technology is warranted because there is a great cost difference (for example, under $1 versus $25) between the bar code and passive tags versus an active tag.

The benefit in using the lease program in the system 44 with such a durable product that allowed more “turns” also allows the benefits of an active RFID tag 12 in the Smart Pallet system to be realized and the objections to passive tag in the marketplace overcome. Active RFID and passive RFID technologies, while often considered and evaluated together, are fundamentally distinct technologies with substantially different capabilities.

The following are characteristics and relative merits of active and passive RFID technologies and their applicability for real-time supply chain asset management. Although they both fall under the “RFID” moniker and are often discussed interchangeably, active RFID and passive RFID are fundamentally different technologies. While both use radio frequency energy to communicate between a tag and a reader, the method of powering the tags is different. Active RFID uses an internal power source 18 (e.g., battery) within the tag 12 to continuously power the tag and its RF communication circuitry. In contrast, passive RFID relies on energy transferred from the reader to the tag to power the tag.

While this distinction may seem minor on the surface, its impact on the functionality of the system is significant. Passive RFID either reflects energy from the reader or absorbs and temporarily stores a very small amount of energy from the reader's signal to generate its own quick response. In either case, passive RFID operation requires very strong signals from the reader, and the signal strength returned from the tag is constrained to very low levels by the limited energy. On the other hand, active RFID allows very low-level signals to be received by the tag (because the reader does not need to power the tag), and the tag can generate high-level signals back to the reader, driven from its internal power source. Additionally, the active RFID tag 12 is continuously powered, whether in the reader field or not. As discussed below, these differences impact communication range, multi-tag collection capability, ability to add sensors and data logging, and many other functional parameters.

Because of the technical differences outlined above, the functional capabilities of active and passive RFID are very different and must be considered when selecting a technology for a specific application. For passive RFID, the communication range is limited by two factors, namely the need for very strong signals to be received by the tag to power the tag, limiting the reader to tag range, and the small amount of power available for a tag to respond to the reader, limiting the tag to reader range. These factors typically constrain passive RFID operation to three meters or less. Depending on the vendor and frequency of operation, the range may be as short as a few centimeters.

As a direct result of the limited communication range of passive RFID, collecting multiple collocated tags within a dynamic operation is difficult and often unreliable. An example scenario is a forklift carrying a pallet with multiple tagged items through a dock door. Identifying multiple tags requires a substantial amount of communication between the reader and tags, typically a multi-step process with the reader communicating individually with each tag. Each interaction takes time, and the potential for interference increases with the number of tags, further increasing the overall duration of the operation. Because the entire collection operation must be completed while the tags are still within the range of the reader, passive RFID is constrained in this aspect. For example, one popular passive RFID systems available today requires more than three seconds to identify twenty tags. With a communication range of three meters, this limits the speed of the tagged items to less than three miles per hour.

Active RFID, such as that used in the pallets 10, has neither constraint on power and can provide communication ranges of a quarter mile. Active RFID is able to collect thousands of tags 12 from a single reader. Additionally, tags 12 can be in motion at more than one hundred miles per hour (100 mph) and still be accurately and reliably collected. One functional area of great relevance of the active RFID system to many supply chain applications is the ability to monitor environmental or status parameters using an RFID tag 12 with built-in sensor capabilities. Parameters of interest may include temperature, humidity, and shock, as well as security and tamper detection.

Because passive RFID tags are only powered while in close proximity to a reader, these tags are unable to continuously monitor the status of a sensor. Instead, they are limited to reporting the current status when they reach a reader. Active RFID tags 12 are constantly powered, whether in range of a reader or not, and are therefore able to continuously monitor and record sensor status, particularly valuable in measuring temperature limits and container seal status. Additionally, active RFID tags 12 can power an internal real-time clock and apply an accurate time/date stamp to each recorded sensor value or event.

Both active and passive RFID technologies are available that can dynamically store data within the tag. However, because of power limitations, passive RFID typically only provides a small amount of read/write data storage, on the order of 128 bytes (1000 bits) or less, with no search capability or other data manipulation features.

Larger data storage and sophisticated data access capabilities require the tag 12 to be powered for longer periods of time and are impractical with passive RFID. Active RFID has the flexibility to remain powered for access and search of larger data spaces, as well as the ability to transmit longer data packets for simplified data retrieval. Active RFID tags are in common use with 128 K bytes (1 million bits) of dynamically searchable read/write data storage.

Based on the functionality provided by each technology, active and passive RFID address different, but often complementary, aspects of supply chain visibility. Passive RFID is most appropriate where the movement of tagged assets is highly consistent and controlled, and little or no security or sensing capability or data storage is required.

Active RFID is best suited where business processes are dynamic or unconstrained, movement of tagged assets is variable, and more sophisticated security, sensing, and/or data storage capabilities are required. In many situations, both technologies play a key role and work together to provide end-to-end, top-to-bottom supply chain visibility.

The following section presents several common application requirements and the relative fit of active and passive RFID. In many applications, there is a need to continuously or periodically monitor the presence and status of tagged assets and items over a large area. Examples include collecting real-time inventory information within a warehouse, monitoring the location of empty and loaded air cargo containers across an air terminal or tarmac, and monitoring the security of ocean containers or trailers stored in a yard or terminal. Because of the necessity for long-range communication, area monitoring is only available with active RFID.

Portals of various sizes, shapes, and uses are common throughout supply chains. Essentially, any sort of gate, doorway, or other opening through which items move fits this category, including dock doors at a distribution center, entry/exit gates at an inter-modal terminal, and conveyor checkpoints within a parcel sorting operation.

Identifying multiple tagged items moving through a portal requires two capabilities, namely high-speed multi-tag 12 collection and the ability to locate all tags within the portal (and none in adjacent areas). For large portal applications, such as roadside monitoring of an eight-lane highway, only active RFID provides the necessary communication range to cover the portal. RFID-based electronic seals are an effective means of securing all forms of cargo as noted above. Both passive and active RFID can be used for electronic seals, but each provides different capabilities and levels of security.

Passive RFID security solutions are good for applications where simple tamper detection is sufficient, the exact time of a tampering event is not important, and concern about sophisticated thieves attempting to “spoof” the seal are minimal. Because passive RFID tags cannot be powered while the cargo is in transit, they cannot continuously monitor the presence and status of the cargo seal. They can only report if the seal appears intact at the next read point.

Active RFID, on the other hand, can continuously monitor the seal status, detecting minute variations in the seal position or integrity and implementing sophisticated anti-spoofing techniques. Immediately upon detection of a problem, the date and time and event code can be logged in the tag's memory, providing a complete audit trail of all events during the shipment.

For supply chain applications where there is a need to store an electronic manifest within the tag, such as customs inspection, only active RFID is an appropriate option. Passive RFID does not provide sufficient data storage or data search capabilities.

A key consideration in any implementation of RFID is the impact on business processes. Clearly, the objective is to minimize these impacts, but they are difficult to eliminate completely. As a general rule, active RFID requires significantly fewer changes to existing business processes than Passive RFID. There are several reasons for this, namely passive RFID has a very limited read range, requiring tagged assets and items to move along well-defined paths and past specific read points, passive RFID has limited multi-tag collection capabilities, requiring large groupings of tagged items to be dispersed before passing a read point, and passive RFID is unable to read tags moving at high speed. The result is that passive RFID may require substantial process re-design and worker training to be effectively implemented. The costs associated with business process re-engineering must be considered, along with the costs of software, tags, and readers, when assessing the total cost of implementation and ownership of an RFID system.

Potential Project Advantages

The pallet 10 may provide advantages in several areas. For example, if agricultural based composites are used (and not limiting the invention to agricultural based materials), the pallets 10 have relevancy to the agricultural industry in the country. The product may utilize by product from ethanol production as a significant part of the composite manufacturing process. Composite materials are a growing industry, but can greatly benefit from lower cost input materials and renewable sources instead of petroleum. The incorporation of agricultural products such as corn oil, soybean oil and DDG in composite materials provides an expanding market for these materials. The opportunity to place an ethanol by-product in advanced materials is beneficial to farmers, ethanol producers and composite material users. On the consumer side, many products used by farmers and residents can be made of these agri-based composite materials.

Today there are more than eighty-one ethanol plants in the United States with the capacity to produce more than 3.6 billion gallons of ethanol annually. There are sixteen ethanol plants and two major expansions under construction with a combined annual capacity of more than seven hundred fifty million gallons.

When ethanol is produced, only the starch from the corn kernel is used. The remaining corn residue, called DDG's has been viewed as more of a by-product than a co-product. Traditionally, ethanol plants have marketed DDG's as a beef feedlot and dairy feed ingredient.

As more and more ethanol processing plants are built in response to demand for ethanol, there will be an increasing supply of DDG's. Analysts predicts that the industry will double in the next three years. By finding more uses for DDG's now, ethanol plants can potentially maintain or improve their profitability even as competition increases. About 3.2 to 3.5 million metric tons of DDG's are produced annually in North America.

In recent years, some regions of the U.S. have required the use of oxygenated fuels (e.g. ethanol-gasoline blends) to reduce air pollution from automobile emissions. Because of the increased demand for ethanol, the production of DDG's is expected to double within the next few years, further increasing the quantity of DDG's available for use in livestock feeds.

As for the likely improvement to the local rural economy and improved profitability to the agricultural producer, this project addresses both. There is economic benefit realized from the corn product as a manufacturing raw material resource has become evident as conventional materials, such as steel are becoming a less viable alternative for industrial manufacturing as prices continued to spike for the inputs as well as source materials being hard to find in this country. The Wall Street Journal reports that Brazil's Cia. Vale do Rio Doce S.A. (CVRD), the largest iron ore supplier in the world, has just negotiated a price increase with Japanese steel makers that will bring the price of ore up 71%. This signals some real problems for the coming months as steelworkers will use the higher ore prices to get their own prices up, whether they buy ore from CVRD or not. Historically, CVRD has set the benchmark for negotiations on ore prices, whether it be in Japan, Europe or the United States.

The project creates manufacturing diversification into bio-based products as well as generating manufacturing job opportunities. This project creates jobs that have been lost in trades that have found a more feasible overseas market. These jobs can be recreated with this new emerging technology. This includes the rural economy, where the corn can be sourced as the “best cost” point of origin. Finally, the project adds value to corn and benefits the producer who supplies the material used in this product as the corn's physical state is changed into resin and foam utilized in the composite manufacturing methods utilized in this project.

Another area of relevance is the replacement of almost exclusive petroleum based materials currently used in the composite manufacturing industry. This proposal provides a competitive advantage for bio-based industry as it utilizes agricultural materials, like corn, that need additional market opportunities in the future.

The recent spike of prices and in the steel and petroleum industry and public awareness of the values of these products showing a price effective replacement for steel and aluminum in the marketplace that utilizes a plentiful, reliable, and renewable resource like corn offer an excellent opportunity for products that utilize this agricultural based composite manufacturing system.

Another advantage that can be achieved through active RFID is the observed identified efficiency increases by using a traceability system to make process adjustments on a real-time basis in an operation. Enhanced traceability provides the ability to track the variation in output to an individual production unit. Being able to pin down this level of specificity also enables the producer to compare benefits.

Increases in operational efficiency and supply chain management effectiveness are key longer-term benefits enabled by more robust traceability processes and systems. Based on other industries' experiences and observations of the supply chain, this area has significant potential for justifying investment in traceability.

Not to be forgotten is the use of traceability as a risk mitigation tool to protect public health. Traceability also acts as an effective risk management tool for organizations seeking to reduce their liability exposure. Therefore, there are insurance and regulatory-related benefits that partly hinge on compliance. These costs can be reduced by implementing traceability processes and systems. The most compelling benefit in this category comes from the ability to more accurately identify problem lots, their location and source.

As a whole, an effective traceability system helps reduce the potential scope of a disaster. In a RCM Technologies examination of the food industry, the company has seen that full traceability can cut the scope of a recall in half, and observed scenarios where recall scope was lowered by more than 95%. As well as savings in discarded food product, reducing scope reduces the number of customers affected and negative impacts on market profile and perception of the problem which is not a trivial benefit.

A whole-chain traceability system reduces the time required to withdraw product. In the case of potentially hazardous product, this is particularly relevant since it will ultimately reduce exposure to liability claims. Faster response can decrease the severity of a recall by withdrawing product before it is sold to the public and possibly consumed. The relevance of speed is highlighted in a U.S. recent study, which found that over half of meat recalled is never recovered and thus has been consumed (Hooker 2004).

One can assess the benefit of improved recall and risk management by considering the reduction in recall scope, the frequency of different types of recalls, the market reaction to recalls and withdrawals, and the liability exposure. Each of these benefits will yield quantifiable business benefits to an operation.

All references, including publications, patent applications, and patents cited herein are hereby incorporated by reference to the same extent as if each reference were individually and specifically indicated to be incorporated by reference and were set forth in its entirety herein.

In the future, the cost of active RFID will come down to a point where it will be cost effective to place active RFID within individual packages as well as embedded within the pallet 10. When that occurs, the system 44 will then monitor every item that is on the pallet and report the time and location of when items are removed.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A pallet comprising:
a pallet body configured to be transported by a transport vehicle, the pallet body made at least in part from composite material; and
an active RFID tag including an internal power source, the active RFID tag embedded within the composite material of the pallet body.

2. The pallet of claim 1, wherein the active RFID tag is entirely embedded in the pallet body and is equipped with a memory, and wherein the pallet body includes a non-wood, agricultural input.

3. The pallet of claim 1, wherein the active RFID tag includes a non-volatile memory, the memory storing an identifier that corresponds to the pallet body such that the active RFID tag is able to identify the pallet body associated therewith.

4. The pallet of claim 1, wherein the active RFID tag includes a sensor for sensing a characteristic of the pallet body or a characteristic of an environment surrounding the pallet body.

5. The pallet of claim 4, wherein the active RFID tag includes a battery, the battery having a lifespan of between about one to about five years, and wherein the active RFID tag includes a sensor, the sensor sensing an environmental parameter.

6. The pallet of claim 4, wherein the active RFID includes a sensor and an internal real-time clock, the clock configured to apply a time/date stamp to each recorded sensor event.

7. The pallet of claim 1, wherein the active RFID tag further includes a non-volatile memory and wherein the pallet body forms a central leg, the active RFID tag embedded in the central leg of the pallet.

8. A pallet usage system, comprising:
a plurality of pallets made at least in part of composite material or other primarily non-wood material;
a plurality of active RFID tags, each of the active RFID tags mounted in one of the pallets;
at least one distribution location and at least one destination location, the pallets moving between the distribution and destination locations; and
at least one RFID reader disposed proximate at least one of the distribution and destination locations for sensory communication with the active RFID tags, the RFID reader periodically communicating with the active RFID tags to monitor usage of the pallets.

9. The pallet usage system of claim 8, wherein the active RFID tags mounted in one of the pallets are entirely embedded and the active RFID tags propagate a signal at about four hundred thirty-three megahertz.

10. The pallet usage system of claim 9, wherein the distribution location is a warehouse and the destination location is a retail center.

11. The pallet usage system of claim 10, wherein the plurality of pallets are formed using an agricultural input.

12. A method of leasing pallets, comprising:
providing a plurality of pallets with active RFID tags;
leasing the pallets to a user;
arranging at least one RFID reader in a location for communication with the active RFID tags;
monitoring usage of the pallets by the user through the RFID reader and the active RFID tags; and
determining a lease fee based at least in part on monitored usage.

13. The method of claim 12, wherein the step of determining the lease fee is calculated based on use of a certain number of the pallets for a fixed period of time.

14. The method of claim 12, wherein the step of determining a lease fee is performed by calculating a number of turns of the pallets.

15. An inventory control system, comprising:
a plurality of pallets having inventory contained thereon;
a plurality of active RFID tags mounted to the pallets, the active RFID tags having electronic storage with inventory data relating to the inventory contained thereon; and
means including a RFID transreceiver for modifying the inventory data in the RFID tags as the inventory changes.

16. The inventory control system of claim 15, wherein the pallets include an agricultural input, the electronic storage is a non-volatile memory, and the means includes a battery.

17. The inventory control system of claim 15, wherein the RFID transceiver operates at a frequency of at or below about two gigahertz (2 GHz).

18. The inventory control system of claim 15, further comprising at least one data logger used to log data pertaining to the inventory, the data logger electronically coupled to a network for communication with at least one of a leasing center, a warehouse, and a retail location.

19. A method for maintaining inventory, comprising:
providing a plurality of pallets with an active RFID tag, the active RFID tags having electronic storage;
maintaining inventory on the pallets;
storing data relating to the inventory on the pallets in the electronic storage of the active RFID tags;
modifying the inventory on the pallets;
updating the data in the electronic storage based on modification of the inventory on the pallets;
reading the data stored in the electronic storage of the active RFID tag on the pallets; and
using the data to manage the inventory.

20. The method of claim 19, wherein the method further comprises the step of submitting user instructions to a data logger for management of the pallets.

21. The method of claim 19, wherein the method further comprises the step of tracking a number of turns of the pallets between at least two different locations.

22. The method of claim 21, wherein the method further comprises the step of passing the pallets through a portal prior to the step of reading the data stored in the electronic storage.

23. The method of claim 22, wherein the method further comprises the step of tracking the geographic location of the pallets in real time, and wherein the step of reading the data stored in the electronic storage of the active RFID tag of the first pallet occurs while the first pallet is up to about one quarter of a mile from the reader and traveling at up to about one hundred miles per hour.

24. The method of claim 23, wherein the method further comprises the steps of applying a time and date stamp to each sensor event recorded in the electronic storage using an internal real time clock of the active RFID tag.

25. The method of claim 21, wherein the method further comprises the step of using the data stored in the electronic storage to calculate a lease fee.
